(19) United States
(12) Patent Application Publication
(10) Pub. No.: US 2024/0185038 A1
(43) Pub. Date: Jun. 6, 2024

(54) METHOD FOR EMBEDDING DATA AND SYSTEM THEREFOR

(71) Applicant: SAMSUNG SDS CO., LTD., Seoul (KR)

(72) Inventors: Jeong Hyung PARK, Seoul (KR); Kang Cheol Kim, Seoul (KR); Ju Ree Seok, Seoul (KR)

(73) Assignee: SAMSUNG SDS CO., LTD., Seoul (KR)

(21) Appl. No.: 18/525,014

(22) Filed: Nov. 30, 2023

(30) Foreign Application Priority Data
Dec. 6, 2022 (KR) 10-2022-0168396

(51) Int. Cl. G06N 3/0455; G06N 3/084; G06V 10/774; G06V 10/80

(52) U.S. Cl. CPC G06N 3/0455; G06N 3/084; G06V 10/774; G06V 10/803

(57) ABSTRACT

Provided are a method for generating a summary and system therefor. The method according to some embodiments may include generating a first view sample corresponding to a local view of a reference sample. generating a second view sample corresponding to a view greater than the local view from the reference sample; generating a first output value by inputting the first view sample to a first embedding model. generating a second output value by inputting the second view sample to a second embedding model. and updating parameters of the first embedding model based on a difference between the first output value and the second output value.

### CROSS-REFERENCE TO RELATED APPLICATION

This application claims priority from Korean Patent Application No. 10-2022-0168396 filed on Dec. 6, 2022 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method for embedding data and a system therefor, and more specifically, to a method for embedding single-modal or multi-modal data and a system for performing the method.

### 2. Description of the Related Art

Recently, in the field of deep learning, an interest in a multi-modal task that handles data of several modals or modalities at a time has increased, and accordingly, research into methods for effectively embedding multi-modal data has been continuously conducted.

However, most of the methods for embedding a multi-modal proposed so far require a large amount of paired datasets (i.e., training sets composed of multi-modals) for training of a deep learning model, and thus, a significant cost is required to secure the training sets. Furthermore, performance of the deep learning model largely depends on quality of the training sets, and thus, a significant cost is also required for preprocessing and quality verification of a large amount of training sets.

### SUMMARY

Aspects of the present disclosure provide a method for accurately embedding data of a specific modal, and a system for performing the method.

Aspects of the present disclosure also provide a method for accurately embedding multi-modal data, and a system for performing the method.

Aspects of the present disclosure also provide a method for reducing a cost required for embedding training (e.g., a cost required for securing training sets, etc.), and a system for performing the method.

Aspects of the present disclosure also provide a method for improving performance of various deep learning tasks (e.g., multi-modal tasks), and a system for performing the method.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some embodiments of the present disclosure, there is provided a method for embedding data performed by at least one computing device. The method may include: generating a first view sample corresponding to a local view of a reference sample; generating a second view sample corresponding to a view greater than the local view from the reference sample; generating a first output value by inputting the first view sample to a first embedding model; generating a second output value by inputting the second view sample to a second embedding model; and updating parameters of the first embedding model based on a difference between the first output value and the second output value.

In some embodiments, the parameters of the first embedding model may be updated through backpropagation based on the difference between the first output value and the second output value, and parameters of the second embedding model may not be updated through the backpropagation.

In some embodiments, the method may further include: updating parameters of the second embedding model based on the updated parameters of the first embedding model; and further updating the parameters of the first embedding model for other reference sample using the updated second embedding model.

In some embodiments, the parameters of the second embedding model may be updated based on an exponential moving average (EMA) of values of the updated parameters of the first embedding model.

In some embodiments, the first output value may be an embedding of the first view sample output through the first embedding model, and the second output value may be an embedding of the second view sample output through the second embedding model.

In some embodiments, the first output value may be a value obtained by performing a predefined task based on an embedding of the first view sample output through the first embedding model, and the second output value may be a value obtained by performing the predefined task based on an embedding of the second view sample output through the second embedding model.

In some embodiments, the reference sample may be an image sample, the first view sample may be an image corresponding to a first area of the image sample, the second view sample may be an image corresponding to a second area of the image sample, and a size of the second area may be greater than that of the first area.

In some embodiments, the reference sample may be a text sample, and the second view sample may include more main words associated with the text sample than the first view sample.

In some embodiments, the reference sample may be a text sample, and the second view sample may be a text having a greater length than the first view sample.

In some embodiments, the reference sample may be a text sample, the first embedding model or the second embedding model may include an embedding layer mapping an input text to an embedding space, and the generating of the first view sample may include: generating a reference view sample corresponding to a local view of the text sample; mapping the reference view sample to a point on the embedding space through the embedding layer; and generating the first view sample based on the mapped point, the first view sample being a point on the embedding space.

In some embodiments, the reference sample may be a text sample, view samples corresponding to the local view may further include another view sample in addition to the first view sample, and the generating of the second view sample may include generating the second view sample by combining at least some of the view samples corresponding to the local view with each other.

In some embodiments, the reference sample may be a multi-modal sample including a pair of a first sample belonging to a first modal and a second sample belonging to a second modal, and the second modal may be a modal different from the first modal.

In some embodiments, the first embedding model may include: a first embedding layer configured to receive a sample of the first modal and generating a first embedding; a second embedding layer configured to receive a sample of the second modal and generating a second embedding; and an encoder configured to encode the first embedding and the second embedding together to generate a multi-modal embedding.

In some embodiments, the first view sample may include first modal view samples corresponding to local views of the first sample and the second sample, and the second view sample comprises second modal view samples corresponding to views greater than the local views of the first sample and the second sample.

In some embodiments, the first view sample may include a first modal view sample corresponding to a first local view of the first sample and a second modal view sample corresponding to a second local view of the second sample, and the second view sample may include a third modal view sample corresponding to a view greater than the first local view and a fourth modal view sample corresponding to a view greater than the second local view.

In some embodiments, the method may further include: performing a target task using the updated first embedding model.

In some embodiments, the first embedding model may be a model receiving a multi-modal sample comprising a pair of a sample of a first modal and a sample of a second modal and generating a multi-modal embedding, and the performing of the target task may include: constructing an input sample using a non-dummy sample belonging to the first modal and a dummy sample belonging to the second modal; obtaining a multi-modal embedding for the input sample by inputting the input sample to the first embedding model; extracting an embedding corresponding to the dummy sample from the obtained multi-modal embedding; and performing a multi-modal task based on the extracted embedding.

In some embodiments, the multi-modal task may be a text-to-image retrieval task or an image-to-text retrieval task, the non-dummy sample is a query sample belonging to the first modal, and the performing of the multi-modal task may include: selecting a sample of which a similarity to the extracted embedding is greater than or equal to a reference value among samples belonging to the second modal; and providing the selected sample as a retrieval result for the query sample.

According to another embodiments of the present disclosure, there is provided a system for embedding data. The system may include: one or more processors; and a memory storing one or more instructions, wherein the one or more processors, by executing the stored one or more instructions, perform operations including: generating a first view sample corresponding to a local view of a reference sample; generating a second view sample corresponding to a view greater than the local view from the reference sample; generating a first output value by inputting the first view sample to a first embedding model; generating a second output value by inputting the second view sample to a second embedding model; and updating parameters of the first embedding model based on a difference between the first output value and the second output value.

According to yet another embodiments of the present disclosure, there is provided a computer program stored in a computer-readable recording medium coupled to a computing device to execute operations including: generating a first view sample corresponding to a local view of a reference sample; generating a second view sample corresponding to a view greater than the local view from the reference sample; generating a first output value by inputting the first view sample to a first embedding model; generating a second output value by inputting the second view sample to a second embedding model; and updating parameters of the first embedding model based on a difference between the first output value and the second output value.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an illustrative diagram for schematically describing a process in which a system for embedding data according to some exemplary embodiments of the present disclosure performs single-modal embedding training;

FIG. 2 is an illustrative diagram for schematically describing a process in which the system for embedding data according to some exemplary embodiments of the present disclosure performs multi-modal embedding training;

FIG. 3 is an illustrative diagram for schematically describing a process in which the system for embedding data according to some exemplary embodiments of the present disclosure performs a multi-modal retrieval task;

FIG. 4 is an illustrative flowchart illustrating a method for embedding single-modal data according to some exemplary embodiments of the present disclosure;

FIG. 5 is an illustrative diagram for describing a structure and an operation of an embedding model for a single-modal according to some exemplary embodiments of the present disclosure;

FIG. 6 is an illustrative diagram for describing a single-modal embedding training method according to some exemplary embodiments of the present disclosure;

FIG. 7 is an illustrative diagram for describing a single-modal embedding training method according to some other exemplary embodiments of the present disclosure;

FIG. 8 is an illustrative diagram for describing a method for generating a view sample based on text augmentation according to some exemplary embodiments of the present disclosure;

FIG. 9 is an illustrative diagram for describing a method for generating a view sample based on text augmentation according to some other exemplary embodiments of the present disclosure;

FIG. 10 is an illustrative diagram for describing a method for generating a view sample based on image augmentation according to some exemplary embodiments of the present disclosure;

FIG. 11 is an illustrative flowchart illustrating a method for embedding multi-modal data according to some exemplary embodiments of the present disclosure;

FIG. 12 is an illustrative diagram for describing a method for generating a view sample according to some exemplary embodiments of the present disclosure;

FIG. 13 is an illustrative diagram for describing a method for generating a view sample according to some other exemplary embodiments of the present disclosure;

FIG. 14 is an illustrative diagram for describing a method for generating a view sample according to some other exemplary embodiments of the present disclosure;

FIGS. 15 and 16 are diagrams illustrating view samples that may be referenced in some exemplary embodiments of the present disclosure;

FIG. 17 is an illustrative diagram for describing a structure and an operation of an embedding model for a multi-modal according to some exemplary embodiments of the present disclosure;

FIG. 18 is an illustrative diagram for describing a method for segmenting an image according to some exemplary embodiments of the present disclosure;

FIG. 19 is an illustrative diagram for describing a multi-modal embedding training method according to some exemplary embodiments of the present disclosure;

FIG. 20 is an illustrative diagram for describing a method for performing a multi-modal retrieval task according to some exemplary embodiments of the present disclosure; and

FIG. 21 is a diagram illustrating an illustrative computing device capable of implementing the system for embedding data according to some exemplary embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will be defined by the appended claims and their equivalents.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, various exemplary embodiments of the present disclosure will be described in detail with reference to the accompanying drawings.

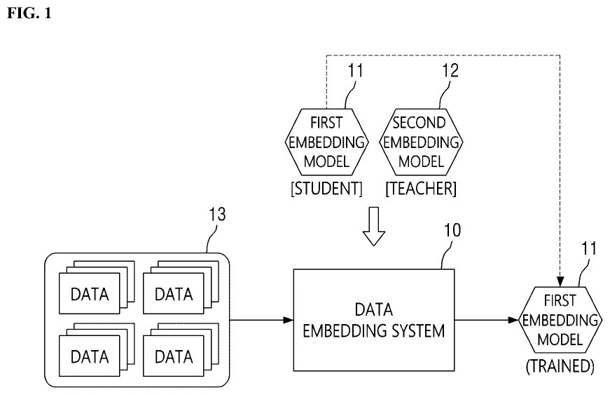

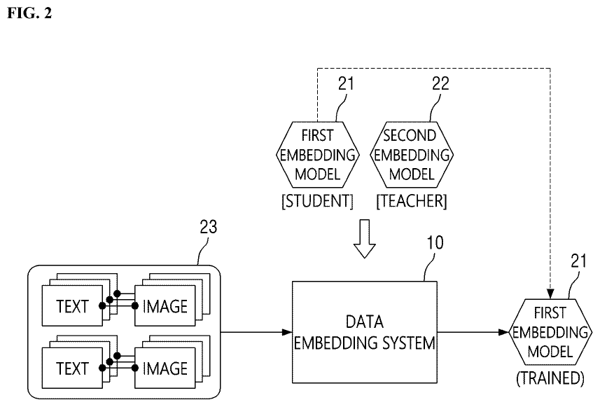

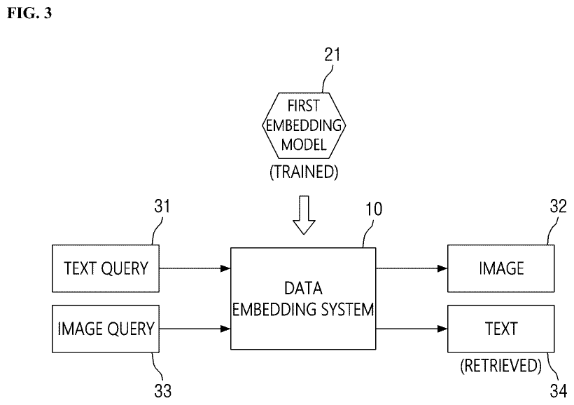

FIGS. 1 to 3 are illustrative diagrams for schematically describing operations of a system 10 for embedding data according to some exemplary embodiments of the present disclosure. FIG. 1 assumes an environment that handles data of a specific modal (or modality) (i.e., single-modal data), and FIGS. 2 and 3 assume a multi-modal environment that handles a text and an image together.

As illustrated in FIG. 1 and the like, a system 10 for embedding data may be a system capable of embedding given data through a deep learning-based embedding model (e.g., 11). For example, the system 10 for embedding data may train an embedding model (e.g., 11 or 21) using a training set (e.g., 13 or 23) and embed data using the trained embedding model (e.g., 11 or 21). Hereinafter, for convenience of explanation, the system 10 for embedding data will be abbreviated as an ‘embedding system 10’.

Specifically, as illustrated in FIG. 1, the embedding system 10 may train a first embedding model 11 using a training set 13 composed of samples (i.e., data samples) of a specific modal. In this case, the embedding system 10 may train the first embedding model 11 with the help (or teaching) of a second embedding model 12. The modal of the samples may be, for example, a text, an image, a voice, or the like, but the scope of the present disclosure is not limited thereto.

For reference, the ‘sample’ or the ‘data sample’ refers to each data constituting the training set (e.g., 13), and may be used interchangeably with terms such as an ‘example’, an ‘instance’, an ‘observation’, and ‘individual data’ in the art.

In detail, the embedding system 10 may generate a first view sample corresponding to a local view and a second view sample corresponding to a view greater than the local view using each sample constituting the training set 13 as a reference sample. In addition, the embedding system 10 may update parameters of the first embedding model 11 based on a difference between a first output value (e.g., an embedding, a task performing result, etc.) obtained by inputting the first view sample to the first embedding model 11 and a second output value obtained by inputting the second view sample to the second embedding model 12. As such a process is repeatedly performed on other samples of the training set 13, the first embedding model 11 may have an embedding capability for the data of the specific modal.

Here, the reference sample (or a base sample) may refer to a sample that is a reference for generating a view sample. In some cases, the reference sample may be referred to as a term such as an ‘original sample’ or an ‘anchor sample’.

In addition, the ‘local view’ may conceptually refer to a view that looks at only a portion (or a local range) of the reference sample. In addition, the ‘view greater than the local view’ may conceptually refer to a view that looks at a greater portion (or range) of the reference sample than the local view (e.g., a global view that looks at the entire reference sample). Hereinafter, for convenience of explanation, the view greater than the local view will be collectively referred to as a ‘global view’. In addition, in some cases, in order to clarify the present disclosure, terms such as ‘local view sample’ and ‘global view sample’ may be used instead of the ‘first view sample’ and the ‘second view sample’.

Alternatively, the local view may be defined based only on a relative relationship with the global view regardless of the reference sample. That is, the local view may simply refer to a view smaller than the global view.

In any case, the second view sample cannot but be a sample having more information than the first view sample. Accordingly, the second embedding model 12 may provide a teaching (e.g., a second output value that is a reference for error/loss calculation) to the first embedding model 11 based on the second view sample, and from such a viewpoint, it may be understood that the second embedding model 12 serves as a teacher and the first embedding model 11 serves as a student.

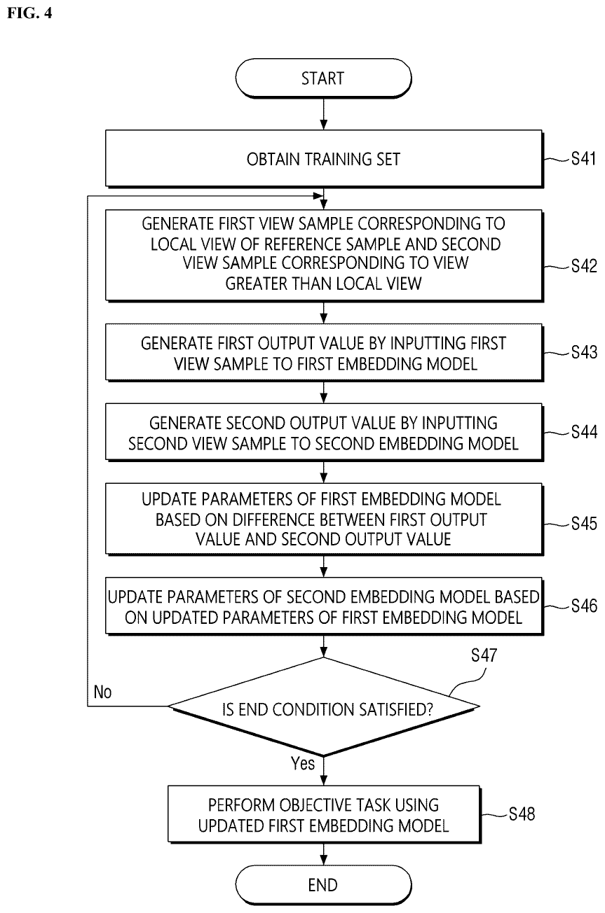

A specific method in which the embedding system 10 trains the first embedding model 11 will be described in more detail later with reference to FIGS. 4 to 10.

In some cases, the embedding system 10 may perform an objective/target task (i.e., a single-modal task) using the trained first embedding model 11. Alternatively, the embedding system 10 may provide the trained first embedding model 11 to a separate device (not illustrated) that performs the objective/target task. Alternatively, the embedding system 10 (or a task performing device) may perform the objective/target task using only the trained second embedding model 12 or using the first embedding model 11 and the second embedding model 12 together.

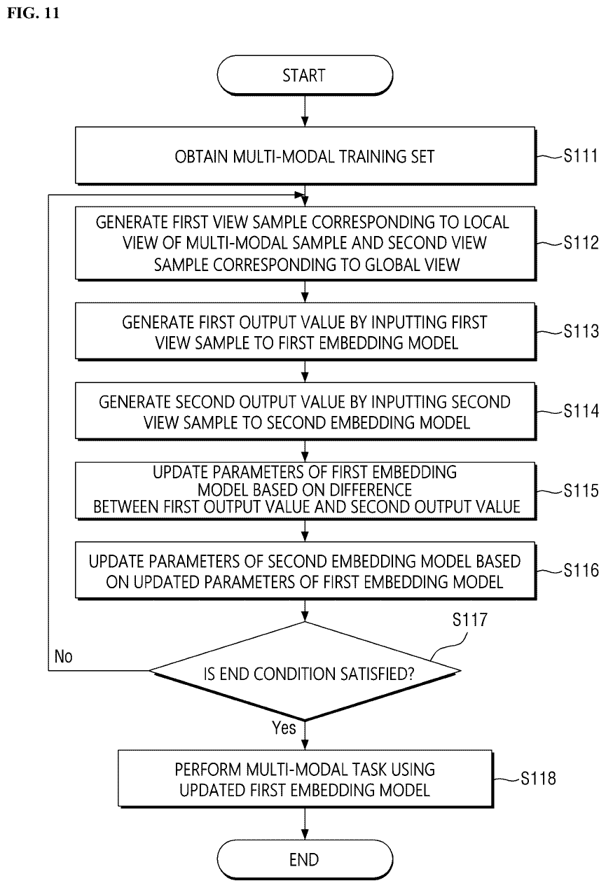

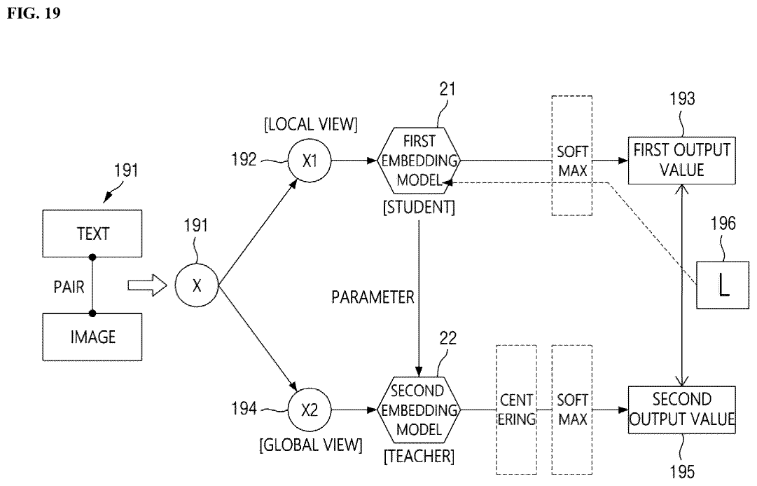

Next, as illustrated in FIG. 2, the embedding system 10 may train a first embedding model 21 using a multi-modal training set 23. That is, the embedding system 10 may train the first embedding model 21 in a similar manner to that described above using a training set 23 composed of pairs of different modal samples. In this way, the first embedding model 21 may have an embedding capability for multi-modal data. This will be described in detail later with reference to FIGS. 11 to 19.

For reference, a ‘multi-modal’ may refer to an environment that handles data of a plurality of modals (or modalities) together. In addition, data of different modals may refer to data of which types, forms, characteristics (e.g. statistical characteristics), and/or domains are different from each other. For example, a text, an image, a voice, and the like, may be treated as the data of the different modals. In addition, for example, a first dataset and a second dataset of which statistical characteristics are different from each other may also be treated as the data of the different modals.

In some cases, the embedding system 10 may perform a multi-modal task (i.e., an objective/target task) using the trained first embedding model 21. For example, as illustrated in FIG. 3, the embedding system 10 may perform a text-to-image retrieval (see a text query sample 31 and a retrieved image sample 32) task and/or an image-to-text retrieval (see an image query sample 33 and a retrieved text sample 34) task using the trained first embedding model 21. However, the scope of the present disclosure is not limited thereto, and the embedding system 10 may also perform other types of multi-modal tasks (e.g., image captioning, visual question and answer, etc.). Alternatively, the embedding system 10 may provide the trained first embedding model 21 to a separate device (not illustrated) that performs the multi-modal task. Alternatively, the embedding system 10 (or a task performing device) may perform the multi-modal task using only the trained second embedding model 22 or using the first embedding model 21 and the second embedding model 22 together.

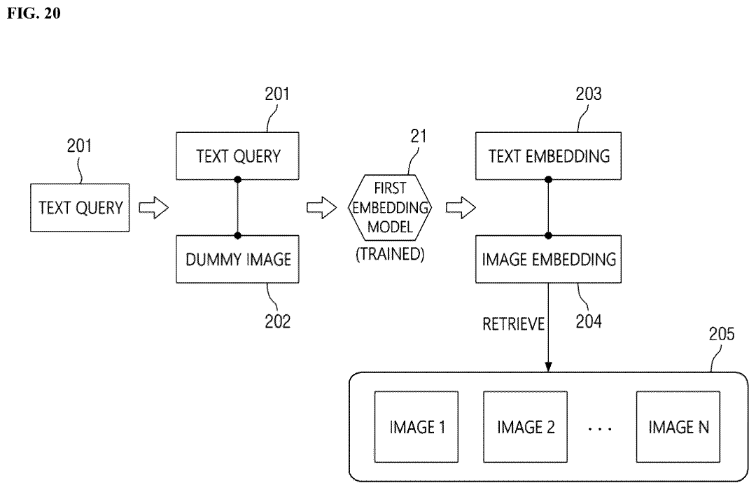

A specific method in which the embedding system 10 performs the text-to-image retrieval and/or image-to-text retrieval tasks will be described in detail later with reference to FIG. 20.

The embedding system 10 described above may be implemented as at least one computing device. For example, all functions of the embedding system 10 may be implemented in one computing device or a first function of the embedding system 10 may be implemented in a first computing device and a second function of the embedding system 10 may be implemented in a second computing device. Alternatively, specific functions of the embedding system 10 may be implemented in a plurality of computing devices.

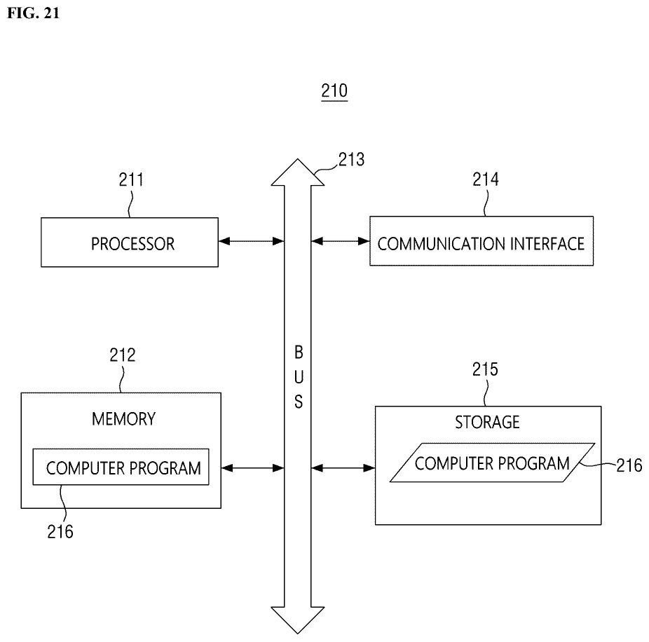

The computing device may include any device having a computing function, and reference is made to FIG. 21 for an example of such a device.

So far, the operations of the embedding system 10 according to some exemplary embodiments of the present disclosure has been schematically described with reference to FIGS. 1 to 3. Hereinafter, various methods that may be performed in the embedding system 10 described above will be described with reference to FIG. 4 and the drawings after FIG. 4. However, in order clarify the present disclosure, when reference is not directly made to the drawings, reference numbers of the embedding models 11, 12, 21, and 22 may be omitted.

Hereinafter, in order to provide convenience of understanding, a description will be provided on the assumption that all steps/operations of methods to be described later are performed in the embedding system 10 described above. Accordingly, when a subject of a specific step/operation is omitted, it may be understood that the specific step/operation is performed in the embedding system 10. However, in a real environment, some steps of methods to be described later may be performed in another computing device.

FIG. 4 is an illustrative flowchart illustrating a method for embedding single-modal data according to some exemplary embodiments of the present disclosure. However, this is only an exemplary embodiment for achieving an object of the present disclosure, and some steps may be added or deleted, if necessary.

As illustrated in FIG. 4, the method for embedding single-modal data according to exemplary embodiments may start in step S41 of obtaining a training set. The training set may be composed of a plurality of samples, and each of the samples may be data of a specific modal (e.g., a text, an image, a voice, etc.). In addition, each of the plurality of samples may be used as a reference sample for generating view samples.

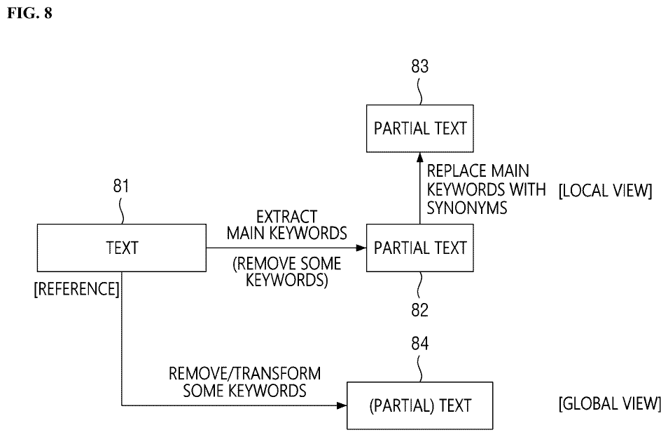

In step S42, a first view sample (i.e., a local view sample) corresponding to a local view of the reference sample and a second view sample (i.e., a global view sample) corresponding to a global view may be generated. For example, the embedding system 10 may generate the respective view samples using a data augmentation technique. However, a specific manner of generating the view sample may be changed depending on a modality of the sample, or the like, which will be described later with reference to FIGS. 8 to 10.

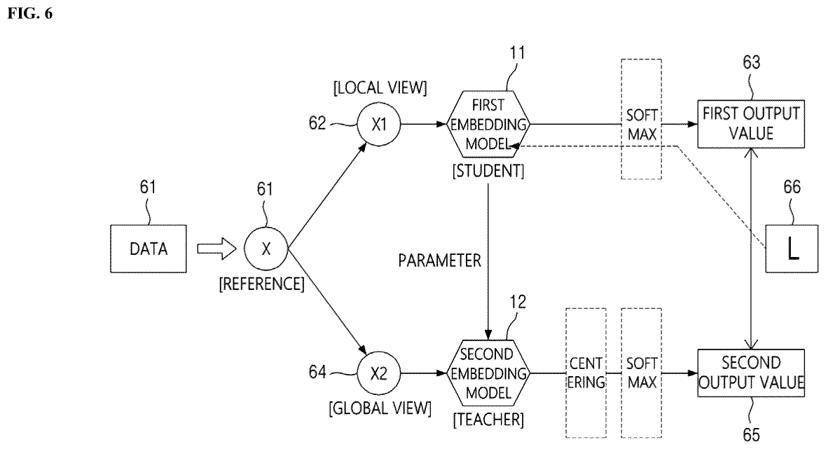

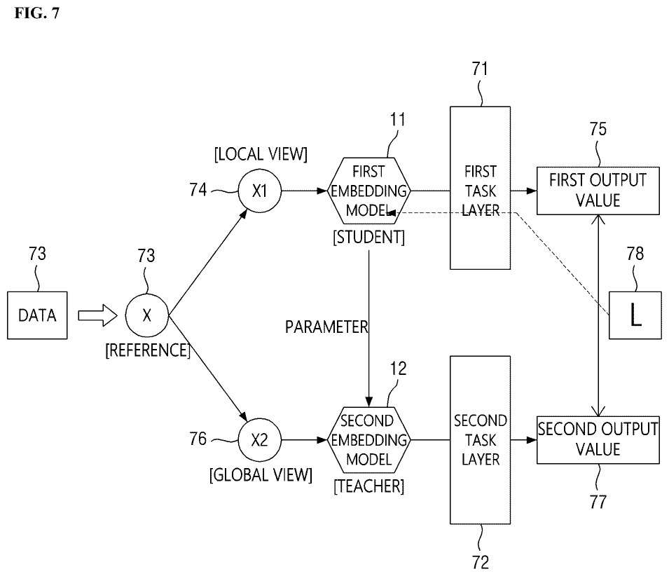

In step S43, a first output value may be generated by inputting the first view sample to the first embedding model (e.g., 11 in FIG. 1). In this case, the first output value may refer to an embedding (e.g., an embedding vector) of the first view sample (see FIG. 6) or refer to a result of performing a predefined task based on the embedding of the first view sample (see FIG. 7), which will be further described later.

In step S44, a second output value may be generated by inputting the second view sample to the second embedding model (e.g., 12 in FIG. 1). In this case, the second output value may also refer to an embedding (e.g., an embedding vector) of the second view sample (see FIG. 6) or refer to a result of performing a predefined task based on the embedding of the second view sample (see FIG. 7), which will be further described later.

As described above, the second embedding model may refer to a model that provides the teaching (e.g., the second output value that is the reference for loss calculation) to the first embedding model using the second view sample including more information than the first view sample. As described later, parameters of the second embedding model are updated based on parameter values of the first embedding model, and thus, the second embedding model may be designed in the same structure as the first embedding model.

The above-described embedding model (i.e., the first embedding model and/or the second embedding model) may be a pre-trained model or be a model in an initialized state. As an example, in the case of training text embedding, a pre-trained text embedding model (e.g., BERT, ROBERTa, XLM-ROBERTa, etc.) may be used as the first embedding model and/or the second embedding model. As another example, in the case of training image embedding, a pre-trained image embedding model (e.g., a visual transformer, etc.) may be used as the first embedding model and/or the second embedding model. For reference, in the art, the embedding model may be referred to as a term such as an ‘encoder’ or an ‘embedder’, and a text embedding model may be referred to as a term such as a ‘language model’.

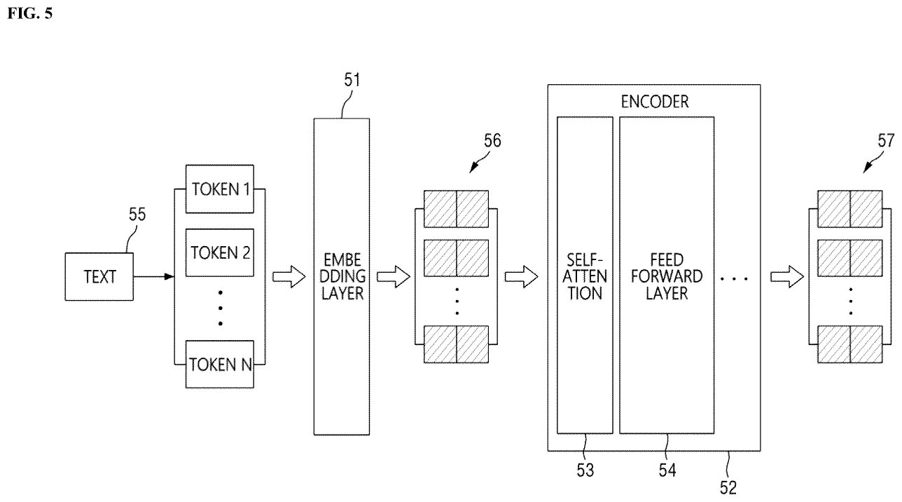

The above-described embedding model may be designed in various structures, and may be designed in any structure. An illustrative structure of a model that performs text embedding is illustrated in FIG. 5. However, even in the case of embedding data of other modals such as an image or a voice, the embedding model may be designed to have a structure similar to that illustrated in FIG. 5 (e.g., see visual transformer).

As illustrated in FIG. 5, an illustrated embedding model may be configured to include an embedding layer 51 and an encoder 52. FIG. 5 assumes that the embedding model is configured to receive a sequence of tokens and output embeddings 57 in token units (e.g., a transformer-based neural network, etc.), but the scope of the present disclosure is not limited thereto. For example, the encoder 52 may also be configured to output a single embedding for an input text sample 55 rather than the embeddings in token units.

The embedding layer 51 may refer to a module that receives tokens constituting the text sample 55 (e.g., receives a one-hot vector of each of the tokens) and generates embeddings in token units. The embedding layer 51 may be implemented as a neural network such as a multi-layer perceptron, but the scope of the present disclosure is not limited thereto. In some cases, the multi-layer perceptron may be referred to as a term such as a ‘fully-connected layer’ or a ‘feed forward layer’.

Next, the encoder 52 may refer to a module that encodes input embeddings in token units together to generate output embeddings in token units. As illustrated in FIG. 5, the encoder 52 may be configured to include at least one self-attention module 53 and at least one feed forward layer 54. However, the scope of the present disclosure is not limited thereto. The self-attention module 53 may analyze an association between input embeddings, and the feed forward layer 54 may collect information of the input embeddings based on an association analysis results. Configurations and operation principles of the self-attention module 54 and the feed forward layer 54 have been already known well by one of ordinary skill in the art, and a detailed description thereof will thus be omitted.

For reference, an embedding (e.g., 56 or 57) output from the embedding layer 51 or the encoder 52 may refer to a representation in an embedding space, and may usually have a vector format, and thus, may also be referred to as a term such as an ‘embedding representation’ or an ‘embedding vector in some cases’. In addition, in the art, the embedding vector may be referred to as a term such as an ‘embedding code’, a ‘latent representation’, a ‘latent vector’, or a ‘latent code’.

A description will be provided with reference to FIG. 4 again.

In step S45, parameters (i.e., trainable weight parameters) of the first embedding model may be updated based on a difference between the first output value and the second output value. For example, the embedding system 10 may update only the parameters of the first embedding model by backpropagating a value (e.g., a cross-entropy loss, a cosine similarity, etc.) representing the difference between the two output values (i.e., the parameters of the second embedding model are not updated through the backpropagation). Such an update process is repeatedly performed on different samples of the training set, such that the first embedding model may have an embedding capability.

In some exemplary embodiments, each output value may be an output embedding (e.g., an embedding vector) of the embedding model. That is, the parameters of the first embedding model may be updated based on a difference between the embeddings output from the two embedding models. For example, as illustrated in FIG. 6, the embedding system 10 may generate embeddings 63 and 65 of respective view samples 62 and 64 generated from a reference sample 61 by inputting the view samples 62 and 64 to the first embedding model 11 and the second embedding model 12. In addition, the embedding system 10 may update parameters of the first embedding model 11 by backpropagating a value 66 (e.g., a cross-entropy loss, a cosine similarity, etc.) representing a difference between the generated embeddings 63 and 65. In some cases, arithmetic operations such as centering (e.g., zero centering, etc.) and softmax may be performed on embedding values output from the respective embedding models 11 and 12. Such arithmetic operations have been already known well by one of ordinary skill in the art, and a detailed description thereof will thus be omitted. According to the present exemplary embodiments, the parameters of the first embedding model 11 are updated based on a direct embedding error (loss), and thus, performance of the first embedding model 11 may be quickly improved.

In some other exemplary embodiments, each output value may be a result of performing a predefined task based on the output embedding (e.g., the embedding vector) of the embedding model. That is, the parameters of the first embedding model may be updated based on a difference between results of performing a predefined task based on the embeddings output from the two embedding models. For example, as illustrated in FIG. 7, the embedding system 10 may generate embeddings of respective view samples 74 and 76 generated from a reference sample 73 by inputting the view samples 74 and 76 to the first embedding model 11 and the second embedding model 12. Next, the embedding system 10 may perform a predefined task (e.g., a classification task) by inputting the generated embeddings to task layers 71 and 72, respectively. The predefined task may be any task. Next, the embedding system 10 may update the parameters of the first embedding model 11 by backpropagating a value 78 (e.g., a cross-entropy loss, etc.) representing a difference between output values 75 and 77 of the task layers 71 and 72. In this case, the first task layer 71 may also be updated. The second task layer 72 may be updated based on parameter values of the first task layer 71 (e.g., see a description of step S46) or may be updated together with the first embedding model 11 through a backpropagation process. In addition, the first task layer 71 and the second task layer 72 may refer to the same layer (e.g., when they are designed to share weight parameters with each other) or refer to different layers. In some cases, the embedding system 10 may change a task and train the first embedding model 11 in a manner illustrated in FIG. 7 (e.g., replace the task layers 71 and 72 with layers performing another task and then perform training again). According to the present exemplary embodiment, the parameters of the first embedding model 11 are updated based on a task error (loss), and thus, the first embedding model 11 may be trained to generate embeddings suitable for a specific task or various tasks.

In some other exemplary embodiments, the parameters of the first embedding model may be updated based on various combinations of the above-described exemplary embodiments. For example, the embedding system 10 may update the parameters of the first embedding model based on both a first value indicating the difference between the embeddings and a second value indicating the difference between the task performing results (e.g., update the parameters of the first embedding model by calculating a total error/loss based on the sum of weights of the two values and backpropagating the total loss).

In step S46, parameters of the second embedding model may be updated based on the updated parameters of the first embedding model. In this way, the second embedding model serving as the teacher may provide a better teaching to the first embedding model, and performance of the first embedding model serving as the student may also be continuously improved. However, a specific manner of updating the parameters of the second embedding model may be changed depending on exemplary embodiments.

In some exemplary embodiments, the parameters of the second embedding model may be updated based on an exponential moving average (EMA) of values of the updated parameters of the first embedding model. For example, the embedding system 10 may update the parameters of the second embedding model based on Equation 1. In Equation 1, ‘Fₜ’ refers to the values of the parameters of the second embedding model, ‘Fₛ’ refers to the values of the parameters of the first embedding model, and ‘λ’ refers to a weight according to the exponential moving average. The exponential moving average refers to a moving average calculation manner of assigning a higher weight to a recent value, and an equation (i.e. Equation 1) related to a concept of the exponential moving average has been already known well by one of ordinary skill in the art, and a detailed description thereof will thus be omitted. According to the present exemplary embodiment, the parameters of the second embedding model are updated with a greater weight given to a recent state (i.e., the most trained state) of the first embedding model, and thus, the second embedding model may easily provide a better teaching. In addition, as a result, an entire embedding training process may be efficiently performed.

Fₜ=λFₜ+(1−λ)Fₛ [Equation 1]

In step S47, it may be decided whether or not a training end (termination) condition is satisfied. The training end condition may be set based on, for example, the number of repetitions (e.g., the number of epochs), a training time, a magnitude of an error (loss) (i.e., a difference between two output values), and the like, but the scope of the present disclosure is not limited thereto. When the training end condition is satisfied, step S48 may be performed, and otherwise, steps S42 to S46 may be repeatedly performed on other samples of the training set.

In step S48, an objective/target task may be performed using the updated (i.e., trained) first embedding model. For example, the embedding system 10 may generate an embedding of a sample belonging to a specific modal through the updated first embedding model and perform the objective/target task based on the generated embedding. In some cases, the embedding system 10 may provide the updated first embedding model to a separate task performing device, and the task performing device may perform the objective/target task using the provided first embedding model. Alternatively, the embedding system 10 (or the task performing device) may perform the objective/target task using the updated first embedding model and second embedding model together.

The objective/target task may include various types of classification tasks and regression tasks, and may be any task.

In some exemplary embodiments, the embedding system 10 may perform the training illustrated in FIG. 4 using samples of a first local view and may again perform the training illustrated in FIG. 4 using samples of a second local view having a different size from the first local view. In such a case, the performance of the first embedding model may be further improved by training local views having various sizes.

So far, the method for embedding single-modal data according to some exemplary embodiments of the present disclosure has been described with reference to FIGS. 4 to 7. According to that described above, embedding training for data of the specific modal may be performed using the local view sample and the global view sample belonging to the specific modal. In such a case, a task such as labeling does not need to be performed in order to secure a training set of the specific modal, and thus, a cost required for embedding training may be significantly reduced.

In addition, the parameters of the first embedding model may be updated based on the difference between the output value (e.g., the embedding, the task performing result, etc.) obtained by inputting the global view sample to the second embedding model and the output value obtained by inputting the local view sample to the first embedding model. In such a case, the second embedding model may provide the teaching (e.g., the second output value that is the reference for error/loss calculation) to the first embedding model based on the global view sample including more information than the local view sample, and the first embedding model may effectively/efficiently train an embedding capability with the help of the provided teaching. Furthermore, the first embedding model is trained to perform the embedding in consideration of both the local view and the global view, and thus, the performance of the first embedding model may be further improved.

Hereinafter, various exemplary embodiments of a method for generating a view sample will be described with reference to FIGS. 8 to 10.

FIG. 8 is an illustrative diagram for describing a method for generating a view sample based on text augmentation according to some exemplary embodiments of the present disclosure. In FIG. 8, a length of a figure refers to a relative size of a view or a relative length of a text (or the relative number of main words/keywords).

As illustrated in FIG. 8, the present exemplary embodiments relate to a method for generating view samples 82 to 84 using various text augmentation techniques (that is, a case where a reference sample 81 is a text sample).

Specifically, the embedding system 10 may generate local view samples (e.g., 82 and 83) and a global view sample (e.g., 84) using a text augmentation technique. In some cases, a reference sample 81 may be used as a global view sample as it is. For example, the embedding system 10 may generate the view samples so that the global view sample (e.g., 84) is a text including a greater number of main words (e.g., main words/keywords of the reference sample 81) or having a greater length than the local view sample (e.g., 82). However, a specific manner of generating the view samples may be changed depending on cases.

For example, the embedding system 10 may generate the local view sample 82 by extracting one or more main words (e.g., nouns, verbs, etc.) from the reference sample 81 and combining the extracted main words with each other in various manners.

As another example, the embedding system 10 may generate another local view sample 83 by replacing some words of the local view sample 82 with synonyms. The embedding system 10 may also generate the local view sample (e.g., 83) by transforming the reference sample 81 in a manner of replacing some words with synonyms and extracting main words from the transformed reference sample 81.

As still another example, the embedding system 10 may generate the local view sample (e.g., 82) by removing a text (e.g., postpositional particles, articles, etc.) that does not correspond to main words and/or one or more main words from the reference sample 81.

As still another example, the embedding system 10 may generate the local view sample by performing various types of text processing on a specific sample (e.g., the reference sample or the local/global view sample). Examples of such text processing may include insertion/transformation/removal of some words (e.g., a text such as postpositional particles, articles, etc., that does not correspond to main words), change in the order of words, insertion of a noise text, and the like, but the scope of the present disclosure is not limited thereto.

As still another example, the embedding system 10 may generate the local view sample based on various combinations of the examples described above.

In addition, for example, the embedding system 10 may generate the global view sample 84 in a manner of removing or transforming some words (e.g., a text such as postpositional particles and articles that does not correspond to main words) from the reference sample 81.

As another example, the embedding system 10 may generate the global view sample by replacing main words of the reference sample 81 with synonyms.

As still another example, the embedding system 10 may generate the global view sample by changing the order of words constituting the reference sample 81.

As still another example, the embedding system 10 may generate the global view sample by combining the local view samples (e.g., 82, 83, etc.) with each other in various manners.

As still another example, the embedding system 10 may generate the global view sample by performing various types of text processing on a specific sample (e.g., the reference sample or the global view sample).

As still another example, the embedding system 10 may generate the global view sample based on various combinations of the examples described above.

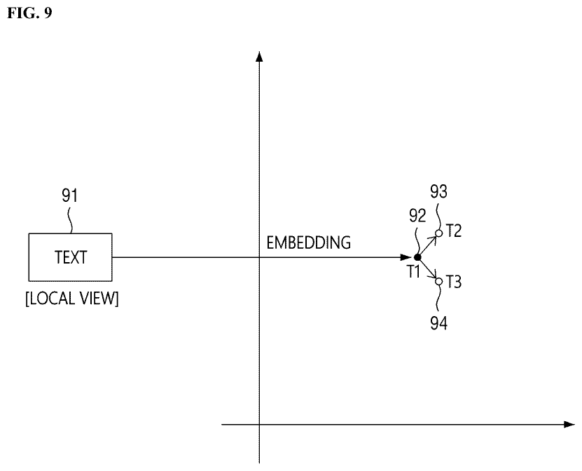

Hereinafter, a method for generating a view sample based on text augmentation according to some other exemplary embodiments of the present disclosure will be described with reference to FIG. 9.

As illustrated in FIG. 9, the present exemplary embodiments relate to a method for generating view samples through a manipulation (i.e., text augmentation) on an embedding space.

In the present exemplary embodiment, the embedding system 10 may generate a plurality of view samples (e.g., 93 and 94) from a reference view sample 91 through a manipulation on an embedding space. FIG. 9 assumes that the reference view sample 91 is a local view sample. However, a description to be provided later may be applied as it is without changing a substantial technical idea even in the case where the reference view sample 91 is a global view sample (or a reference sample). In addition, a description to be provided later may be applied as it is even in the case where a modality of the reference view sample 91 changes (e.g., even in the case of an image, a voice, or the like).

Specifically, the embedding system 10 may map the reference view sample 91 to a point 92 (i.e. an embedding vector) on the embedding space through the embedding layer (e.g., see 51 in FIG. 5) of the embedding model (e.g., the first embedding model 11 or the second embedding model 12). In addition, the embedding system 10 may sample points 93 and 94 positioned within a predetermined distance from the mapped point 92. For example, the embedding system 10 may sample a plurality of points 93 and 94 in a manner of adding random noise to the corresponding point 92 (i.e., the embedding vector).

In this case, the embedding system 10 may use the sampled points 93 and 94 as new view samples (e.g., view samples directly input to the encoder 52 in FIG. 5). In some cases, the embedding system 10 may further sample a new point (i.e., view sample) from the point 92 of the reference view sample and the sampled points 93 and 94 (e.g., further obtain a new point through arithmetic operations such as interpolation, average, etc.).

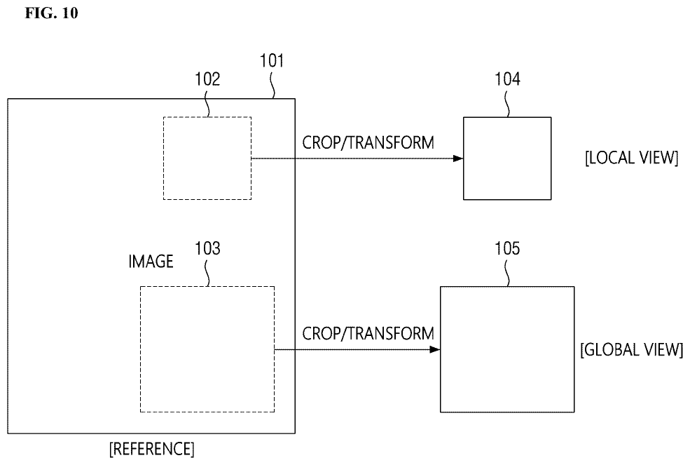

Hereinafter, a method for generating a view sample based on image augmentation according to some exemplary embodiments of the present disclosure will be described with reference to FIG. 10.

As illustrated in FIG. 10, the present exemplary embodiments relate to a method for generating view samples 104 to 105 using various image augmentation techniques (that is, a case where a reference sample 101 is an image sample).

Specifically, the embedding system 10 may generate an image 104 corresponding to a first area 102 of the reference sample 101 as a local view sample and generate an image 105 corresponding to a second area 103 of the reference sample 101 as a global view sample, using various image augmentation techniques. In this case, the first area 102 may refer to a partial area (i.e., a local area) of the reference sample 101, and the second area 103 is an area greater (or wider) than the first area 102 and may refer to an entire area of the reference sample 101 in some cases. However, a specific manner of generating the view samples may be changed depending on cases.

For example, the embedding system 10 may generate the view samples 104 and 105 by cropping (or extracting) the first area 102 and the second area 103 from the reference sample 101, respectively.

As another example, the embedding system 10 may generate the view samples 104 and 105 by further performing various image processing on cropped images corresponding to specific areas 102 and 103. Examples of such image processing may include noise addition, color inversion, image flipping, image rotation, brightness change, pixel value change, gray scale conversion, and the like, but the scope of the present disclosure is not limited thereto. The embedding system 10 may also generate the view samples (e.g., 104 and 105) by performing the image processing described above to transform the reference sample 101 and cropping (or extracting) specific areas from the transformed reference sample 101.

So far, various exemplary embodiments of the method for generating a view sample have been described with reference to FIGS. 8 to 10. According to that described above, a plurality of local view samples and global view samples may be generated from the reference sample through a data augmentation technique suitable for each modal. Accordingly, a large amount of training sets (e.g., multi-modal training sets) used for embedding training may be easily secured, and a cost required for embedding training (e.g., a training set securing cost, a pre-processing cost, a quality verification cost, etc.) may be significantly reduced.

Hereinafter, a method for embedding multi-modal data according to some exemplary embodiments of the present disclosure will be described with reference to FIG. 11 and the drawings after FIG. 11. However, in order to clarify the present disclosure, a description of contents overlapping those of the previous exemplary embodiments will be omitted.

FIG. 11 is an illustrative flowchart illustrating a method for embedding multi-modal data according to some exemplary embodiments of the present disclosure. However, this is only an exemplary embodiment for achieving an object of the present disclosure, and some steps may be added or deleted, if necessary.

As illustrated in FIG. 11, the method for embedding multi-modal data according to exemplary embodiments may start in step S111 of obtaining a multi-modal training set. The multi-modal training set may be composed of a plurality of multi-modal samples, and each multi-modal sample may be composed of a pair of samples belonging to different modals. For example, in the case of training multi-modal embedding for two modals, each multi-modal sample may be composed of a pair of a sample of a first modal and a sample of a second modal. As a more specific example, in the case of training multi-modal embedding for a text and an image, each multi-modal sample may be composed of a pair of a text sample and an image sample. Hereinafter, in order to provide convenience of understanding, a description will be provided on the assumption that the multi-modal sample is composed of a pair of samples of two modals. However, the scope of the present disclosure is not limited thereto, and the multi-modal sample may also include samples for three or more modals.

In step S112, a first view sample corresponding to a local view of a multi-modal sample (i.e., reference sample), and a second view sample corresponding to a global view may be generated. However, a specific manner of generating the view samples may be changed depending on exemplary embodiments.

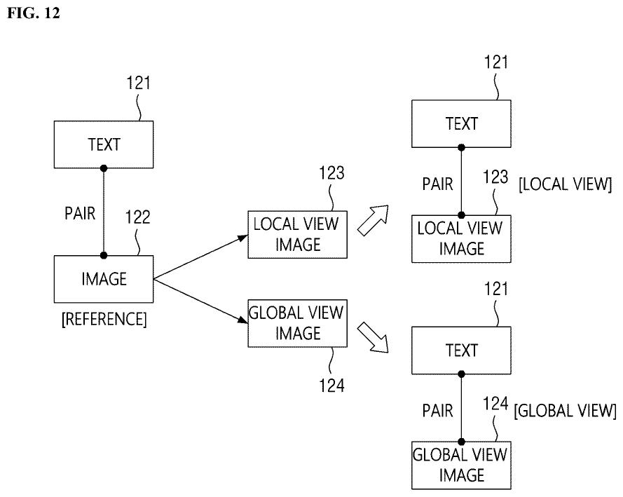

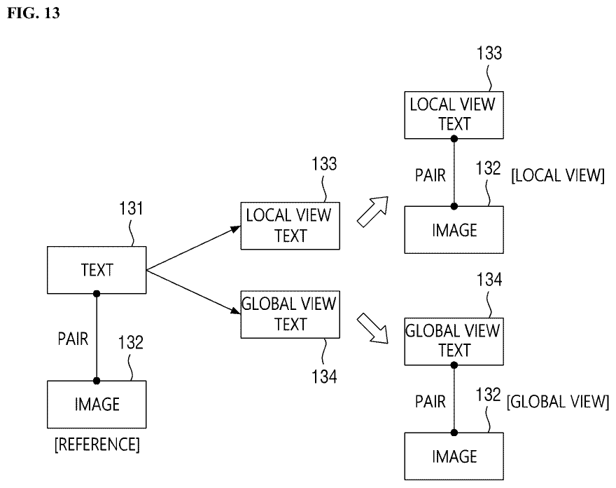

In some exemplary embodiments, a local view sample and a global view sample may be generated only for the sample of the second modal with the sample of the first modal fixed in the multi-modal sample. In addition, the first view sample may be generated by pairing the sample of the first modal and the local view sample of the second modal, and the second view sample may be generated by pairing the sample of the first modal and the global view sample of the second modal. For example, as illustrated in FIG. 12, assume that the multi-modal sample is composed of a pair of a text sample 121 and an image sample 122. In such a case, the embedding system 10 may generate a local view sample 123 and a global view sample 124 only for the image sample 122, and may generate the first view sample by pairing the text sample 121 and the local view sample 123. In addition, the embedding system 10 may generate the second view sample by pairing the text sample 121 and the global view sample 124. Alternatively, as illustrated in FIG. 13, the embedding system 10 may generate a local view sample 133 and a global view sample 134 only for a text sample 131, and may generate the first view sample by pairing an image sample 132 and the local view sample 133 and generate the second view sample by pairing the image sample 132 and the global view sample 134. For a method for generating the local view sample or the global view sample, reference is made to the description of FIGS. 8 to 10.

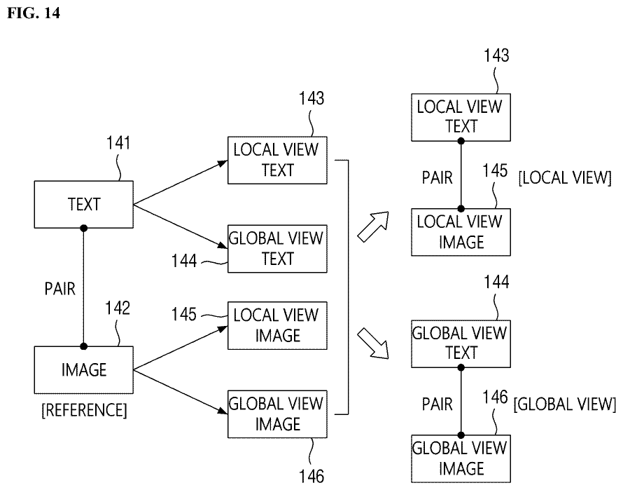

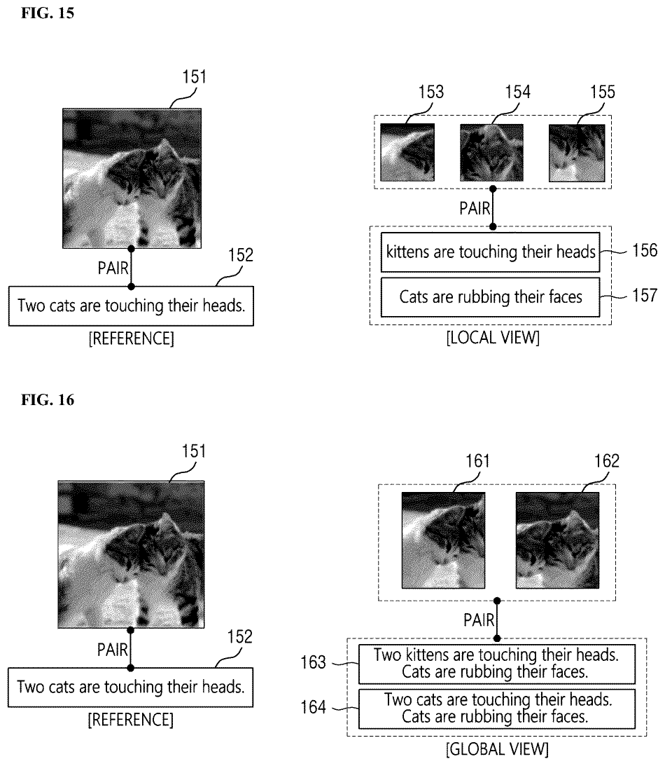

In some other exemplary embodiments, the local view sample and the global view sample may be generated for each modal sample. In addition, the first view sample may be generated by pairing the local view sample of the first modal and the local view sample of the second modal, and the second view sample may be generated by pairing the global view sample of the first modal and the global view sample of the second modal. For example, as illustrated in FIG. 14, assume that the multi-modal sample is composed of a pair of a text sample 141 and an image sample 142. In such a case, the embedding system 10 may generate local view samples 143 and 145 and global view samples 144 and 146 for both the samples 141 and 142. In addition, the embedding system 10 may generate the first view sample by pairing the local view samples 143 and 145 of the respective modals and generate the second view sample by pairing the global view samples 144 and 146 of the respective modals. FIGS. 15 and 16 illustrate a first view sample and a second view sample generated by the method according to the present exemplary embodiment. FIGS. 15 and 16 illustrate a case where a plurality of local view samples (see 153 to 155 and 156 and 157) and global view samples (161 and 162 and 163 and 164) are generated from samples 151 and 152 of respective modals, and it can be seen from FIGS. 15 and 16 that a plurality of training samples (i.e., combinations of local view samples and global view samples) may be generated from one reference sample (see 151 and 152).

A description will be provided with reference to FIG. 11 again.

In step S113, a first output value may be generated by inputting the first view sample to the first embedding model. As described above, the first output value may refer to the embedding (i.e., a multi-modal embedding) output from the first embedding model or may refer to the result of performing the predefined task. For the present step, reference is further made to the description of step S43 described above.

In step S114, a second output value may be generated by inputting the second view sample to the second embedding model. As described above, the second embedding model may refer to a model having the same structure as the first embedding model. For the present step, reference is further made to the description of step S44 described above.

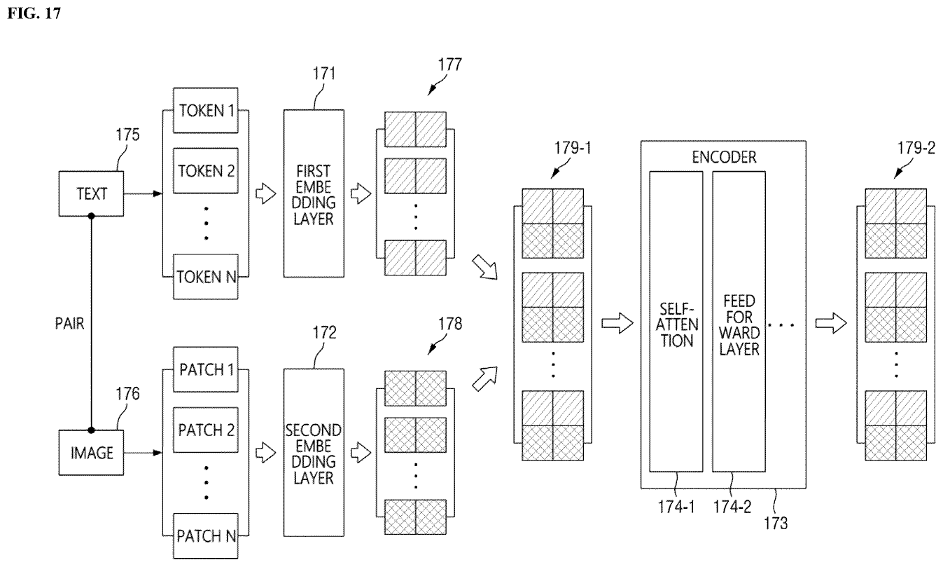

The above-described embedding models (i.e., the first embedding model and/or the second embedding model) may be configured to receive the multi-modal samples and output multi-modal embeddings. An illustrative structure of such an embedding model is illustrated in FIG. 17. FIG. 17 assumes that the embedding model receives a sequence of tokens and a sequence of patches and outputs multi-modal embeddings 179-2. However, the scope of the present disclosure is not limited thereto.

As illustrated in FIG. 17, an illustrative embedding model may be configured to include a first embedding layer 171, a second embedding layer 172, and an encoder 173.

The first embedding layer 171 may refer to a module that receives a sequence of tokens constituting a text sample 175 and generates embeddings in token units. For the first embedding layer 171, reference is made to the description of the embedding layer 51 (see FIG. 5) described above.

Next, the second embedding layer 172 may refer to a module that receives the sequence of patches constituting an image sample 176 and generates embeddings in patch units. The second embedding layer 172 may be implemented based on a convolutional layer, but the scope of the present disclosure is not limited thereto.

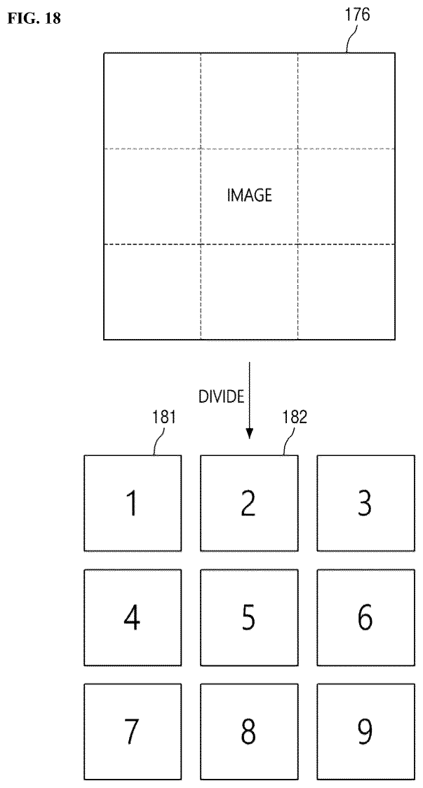

A manner of divide the image sample 176 into a plurality of patches may be various. For example, the image sample 176 may be divided into K×K patches. In this case, K is a natural number of 2 or more, and may be set to a value such as 8 or 16, for example. However, the scope of the present disclosure is not limited thereto. As a more specific example, as illustrated in FIG. 18, the embedding system 10 may divide the image sample 176 into 3×3 patches (181, 182, etc.), and the order of the patches may be predetermined. However, the scope of the present disclosure is not limited thereto.

Next, the encoder 173 may encode embeddings 177 in token units (hereinafter ‘token embeddings’) and embeddings 178 in patch units (hereinafter ‘patch embeddings’) together to generate multi-modal embeddings 179-2. Specifically, the token embeddings 177 and the patch embeddings 178 may be aggregated and input to the encoder 173, and the encoder 173 may encode the aggregated embeddings 179-1 to generate the multi-modal embeddings 179-2. The aggregating may be performed based on, for example, a concatenation operation, but the scope of the present disclosure is not limited thereto.

The encoder 173 may be configured to include at least one self-attention module 174-1 and at least one feed forward layer 174-2. For at least one self-attention module 174-1 and at least one feed forward layer 174-2, reference is made to the description of the encoder 52 (see FIG. 5) described above.

For reference, in the multi-modal embeddings 179-2, embeddings of first portions may be used as embeddings of the text sample 175, and embeddings of second portions may be used as embeddings of the image sample 176. Here, the first portions may correspond to portions where the token embeddings 177 are positioned (or positions when the token embeddings 177 are aggregated) in the input embeddings 179-1 of the encoder 173, and the second portions may correspond to portions (or positions) where the patch embeddings 178 are positioned in the input embeddings 179-1.

A description will be provided with reference to FIG. 11 again.

In step S115, parameters of the first embedding model may be updated based on a difference between the first output value and the second output value. For the present step, reference is made to the description of step S45 described above.

In step S116, parameters of the second embedding model may be updated based on the updated parameters of the first embedding model. For the present step, reference is made to the description of step S46 described above.

In step S1177, it may be decided whether or not a training end condition is satisfied. For the present step, reference is made to the description of step S47 described above.

In step S118, a multi-modal task (i.e., an objective/target task) may be performed using the updated first embedding model. For example, the embedding system 10 may perform the multi-modal task using the multi-modal embedding generated through the updated first embedding model. For the present step, reference is further made to the description of step S48 described above.

As described above, the multi-modal task may include, for example, tasks such as an image-to-text retrieval task, a text-to-image retrieval task, an image captioning task, and a visual question ad answer task. However, the scope of the present disclosure is not limited thereto.

The text-to-image retrieval task or the image-to-text retrieval task will be described in more detail later with reference to FIG. 20.

So far, the method for embedding multi-modal data according to some other exemplary embodiments of the present disclosure has been described with reference to FIGS. 11 to 19. According to that described above, the embedding model (e.g., the first embedding model) may be configured to include the embedding layers that generate embeddings for samples of different modals and the encoder that generates multi-modal embeddings by encoding the embeddings of the different modals together. In such a case, the embedding model does not need to be built for each modal, and thus, a cost required for embedding training may be reduced.

In addition, a plurality of local view samples and global view samples that constitute pairs may be generated from one multi-modal sample. Accordingly, a large amount of multi-modal training sets used for embedding training may be easily secured, and a cost required for embedding training (e.g., a training set securing cost, a pre-processing cost, a quality verification cost, etc.) may be significantly reduced.

Hereinafter, a method for performing a multi-modal retrieval task according to some exemplary embodiments of the present disclosure will be described with reference to FIG. 20. FIG. 20 illustrates a case where the multi-modal retrieval task is a text-to-image retrieval task by way of example.

As illustrated in FIG. 20, the embedding system 10 may perform the text-to-image retrieval task using the trained first embedding model 21.

Specifically, when a query sample 201 (i.e., a text query sample) is received, the embedding system 10 may generate a sample (i.e., a multi-modal sample) to be input to the first embedding model 21 by pairing the query sample 201 and a dummy sample 202 (i.e., a dummy image sample). The dummy sample 202 may be generated in any manner (e.g., the dummy sample 202 may be generated by filling an average value, a mode, a random value, a zero value, or the like, of the corresponding modal).

Next, the embedding system 10 may generate multi-modal embeddings (see 203 and 204) for the input sample through the trained first embedding model 21.

Next, the embedding system 10 may extract an image embedding 204 corresponding to the dummy sample 202 from the generated multi-modal embeddings 203 and 204. As described above, the image embedding 204 may be an embedding corresponding to a specific portion of the multi-modal embeddings, and the specific portion may be determined by a portion where the dummy sample 202 is positioned in the input sample.

Next, the embedding system 10 may retrieve pre-stored image samples 205 using the extracted image embedding 204. For example, the embedding system 10 may calculate a similarity (e.g., a cosine similarity) between the image embedding 204 and an embedding of each of the image samples 205 (i.e., an image embedding generated through the first embedding model 21), and select image samples of which the calculated similarities are is greater than or equal to a reference value. In addition, the embedding system 10 may provide the selected image samples as retrieval results of the query sample 201.

The reason why a retrieval may be performed using the image embedding 204 corresponding to the dummy sample 202 is because the first embedding model 21 has been naturally trained through a plurality of multi-modal samples (that is, pairs of text samples and image samples) so as to output an image embedding (e.g., 204) similar to an embedding (e.g., 203) of an input text sample (e.g., 201) during a training process.

In the case of performing the image-to-text retrieval task, the embedding system 10 may generate an input sample by pairing an image query sample and a dummy sample (i.e., a text dummy sample). In addition, the embedding system 10 may perform the retrieval task in a manner similar to that described above.

Meanwhile, in the case of performing another type of multi-modal task, the embedding system 10 may generate an input sample using a non-dummy sample appropriate for a task instead of the query sample (e.g., 201), and perform a multi-modal task using an embedding corresponding to a dummy sample.

So far, the method for performing a multi-modal retrieval task according to some exemplary embodiments of the present disclosure has been described with reference to FIG. 20. According to that described above, by extracting the embedding corresponding to the dummy sample from the multi-modal embeddings generated through the trained first embedding model, the multi-modal retrieval task may be easily performed through one embedding model.

Hereinafter, an illustrative computing device 210 capable of implementing the embedding system 10 according to some exemplary embodiments of the present disclosure will be described with reference to FIG. 21.

FIG. 21 is an illustrative hardware configuration diagram illustrating a computing device 210.

As illustrated in FIG. 21, the computing device 210 may include one or more processors 211, a bus 213, a communication interface 214, a memory 212 loading a computer program executed by the processor 211, and a storage 215 storing the computer program 216. However, only components related to an exemplary embodiment of the present disclosure are illustrated in FIG. 21. Accordingly, one of ordinary skill in the art to which the present disclosure pertains may know that the computing device 210 may further include other general-purpose components in addition to the components illustrated in FIG. 21. That is, the computing device 210 may further include various components in addition to the components illustrated in FIG. 21. In addition, in some cases, the computing device 210 may be configured in a form in which some of the components illustrated in FIG. 21 are omitted. Hereinafter, respective components of the computing device 210 will be described.

The processor 211 may control overall operations of the respective components of the computing device 210. The processor 211 may be configured to include at least one of a central processing unit (CPU), a micro processor unit (MPU), a micro controller unit (MCU), a graphic processing unit (GPU), or any type of processor well known in the art to which the present disclosure pertains. In addition, the processor 211 may perform an arithmetic operation on at least one application or program for executing operations/methods according to exemplary embodiments of the present disclosure. The computing device 210 may include one or more processors.

Next, the memory 212 may store various data, commands, and/or information. The memory 212 may load the computer program 216 from the storage 215 in order to execute the operations/methods according to exemplary embodiments of the present disclosure. The memory 212 may be implemented as a volatile memory such as a random access memory (RAM), but the technical scope of the present disclosure is not limited thereto.

Next, the bus 213 may provide a communication function between the components of the computing device 210. The bus 213 may be implemented as various types of buses such as an address bus, a data bus, and a control bus.

Next, the communication interface 214 may support wired/wireless Internet communication of the computing device 210. In addition, the communication interface 214 may support various communication manners other than the Internet communication. To this end, the communication interface 214 may be configured to include a communication module well known in the art to which the present disclosure pertains.

Next, the storage 215 may non-temporarily store one or more computer programs 216. The storage 215 may be configured to include a non-volatile memory such as a read only memory (ROM), an erasable programmable (EPROM), an electrically erasable programmable ROM (EEPROM), or a flash memory, a hard disk, a removable disk, or any type of computer-readable recording medium well known in the art to which the present disclosure pertains.

Next, the computer program 216 may include one or more instructions for causing the processor 212 to perform operations/methods according to various exemplary embodiments of the present disclosure when they are loaded into the memory 211. That is, the processor 211 may perform the operations/methods according to various exemplary embodiments of the present disclosure by executing the loaded one or more instructions.

Next, the computer program 216 may include one or more instructions for performing an operation of generating a first view sample corresponding to a local view of a reference sample, an operation of generating a second view sample corresponding to a global view from the reference sample, an operation of generating a first output value by inputting the first view sample to a first embedding model, an operation of generating a second output value by inputting the second view sample to a second embedding model, and an operation of updating parameters of the first embedding model based on a difference between the first output value and the second output value. In such a case, the embedding system 10 according to some exemplary embodiments of the present disclosure may be implemented through the computing device 210.

Meanwhile, in some exemplary embodiments, the computing device 210 illustrated in FIG. 21 may also refer to a virtual machine implemented based on cloud technology. For example, the computing device 210 may be a virtual machine operating on one or more physical servers included in a server farm. In this case, at least some of the processor 211, the memory 212, and the storage 215 illustrated in FIG. 21 may be virtual hardware, and the communication interface 214 may also be implemented as a virtualized networking element such as a virtual switch.

So far, the illustrative computing device 210 capable of implementing the embedding system 10 according to some exemplary embodiments of the present disclosure has been described with reference to FIG. 21.

So far, various exemplary embodiments of the present disclosure and effects according to these exemplary embodiments have been mentioned with reference to FIGS. 1 to 21.

According to some exemplary embodiments of the present disclosure, embedding training for data of a specific modal may be performed using a view sample corresponding to a local view of a reference sample belonging to the specific modal (hereinafter referred to as a ‘local view sample’) and a view sample corresponding to a view greater than the local view (hereinafter referred to as a ‘global view sample’). In such a case, a task such as labeling does not need to be performed in order to secure a training set of the specific modal, and thus, a cost required for embedding training may be significantly reduced.

In addition, a plurality of local view samples and global view samples may be generated from the reference sample through a data augmentation technique suitable for each modal. For example, a plurality of local view samples and global view samples that constitute pairs may be generated from one multi-modal sample. Accordingly, a large amount of training sets (e.g., multi-modal training sets) used for embedding training may be easily secured, and a cost required for embedding training (e.g., a training set securing cost, a pre-processing cost, a quality verification cost, etc.) may be further reduced.

In addition, parameters of a first embedding model may be updated based on a difference between an output value (e.g., an embedding, a task performing result, etc.) obtained by inputting the global view sample to a second embedding model and an output value obtained by inputting the local view sample to the first embedding model. In such a case, the second embedding model may provide a teaching (e.g., a second output value that is a reference for error/loss calculation) to the first embedding model based on the global view sample including more information than the local view sample, and the first embedding model may effectively/efficiently train an embedding capability with the help of the provided teaching. Furthermore, the first embedding model is trained to perform embedding in consideration of both the local view and the global view, and thus, performance of the first embedding model may be further improved.

In addition, the embedding model may be configured to include embedding layers that generate embeddings for samples of different modals and an encoder that generates multi-modal embeddings by encoding the embeddings of the different modals together. In such a case, the embedding model does not need to be built for each modal, and thus, a cost required for embedding training may be further reduced.

In addition, as performance of the embedding model is improved, performance of various deep learning tasks may also be improved. For example, as embedding performance for multi-modal data is improved, performance of a multi-modal task such as an image-to-text retrieval task and a text-to-image retrieval task may also be improved.

The effects according to the technical spirit of the present disclosure are not limited to the aforementioned effects, and various other effects may be obviously understood by one of ordinary skill in the art to which the present disclosure pertains by referencing the detailed description of the present disclosure given below.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for embedding data, performed by at least one computing device, the method comprising:
generating a first view sample corresponding to a local view of a reference sample;
generating a second view sample corresponding to a view greater than the local view from the reference sample;
generating a first output value by inputting the first view sample to a first embedding model;
generating a second output value by inputting the second view sample to a second embedding model; and
updating parameters of the first embedding model based on a difference between the first output value and the second output value.

2. The method of claim 1, wherein the parameters of the first embedding model are updated through backpropagation based on the difference between the first output value and the second output value, and
parameters of the second embedding model are not updated through the backpropagation.

3. The method of claim 1, further comprising:
updating parameters of the second embedding model based on the updated parameters of the first embedding model; and
further updating the parameters of the first embedding model for other reference sample using the updated second embedding model.

4. The method of claim 3, wherein the parameters of the second embedding model are updated based on an exponential moving average (EMA) of values of the updated parameters of the first embedding model.

5. The method of claim 1, wherein the first output value is an embedding of the first view sample output through the first embedding model, and
the second output value is an embedding of the second view sample output through the second embedding model.

6. The method of claim 1, wherein the first output value is a value obtained by performing a predefined task based on an embedding of the first view sample output through the first embedding model, and
the second output value is a value obtained by performing the predefined task based on an embedding of the second view sample output through the second embedding model.

7. The method of claim 1, wherein the reference sample is an image sample,
the first view sample is an image corresponding to a first area of the image sample,
the second view sample is an image corresponding to a second area of the image sample, and
a size of the second area is greater than that of the first area.

8. The method of claim 1, wherein the reference sample is a text sample, and
the second view sample comprises more main words associated with the text sample than the first view sample.

9. The method of claim 1, wherein the reference sample is a text sample, and
the second view sample is a text having a greater length than the first view sample.

10. The method of claim 1, wherein the reference sample is a text sample,
the first embedding model or the second embedding model comprises an embedding layer mapping an input text to an embedding space, and
the generating of the first view sample comprises:
generating a reference view sample corresponding to a local view of the text sample;
mapping the reference view sample to a point on the embedding space through the embedding layer; and
generating the first view sample based on the mapped point, the first view sample being a point on the embedding space.

11. The method of claim 1, wherein the reference sample is a text sample,
view samples corresponding to the local view further comprise another view sample in addition to the first view sample, and
the generating of the second view sample comprises generating the second view sample by combining at least some of the view samples corresponding to the local view with each other.

12. The method of claim 1, wherein the reference sample is a multi-modal sample comprising a pair of a first sample belonging to a first modal and a second sample belonging to a second modal, and
the second modal is a modal different from the first modal.

13. The method of claim 12, wherein the first embedding model comprises:
a first embedding layer configured to receive a sample of the first modal and generating a first embedding;
a second embedding layer configured to receive a sample of the second modal and generating a second embedding; and
an encoder configured to encode the first embedding and the second embedding together to generate a multi-modal embedding.

14. The method of claim 12, wherein the first view sample comprises first modal view samples corresponding to local views of the first sample and the second sample, and
the second view sample comprises second modal view samples corresponding to views greater than the local views of the first sample and the second sample.

15. The method of claim 12, wherein the first view sample comprises a first modal view sample corresponding to a first local view of the first sample and a second modal view sample corresponding to a second local view of the second sample, and
the second view sample comprises a third modal view sample corresponding to a view greater than the first local view and a fourth modal view sample corresponding to a view greater than the second local view.

16. The method of claim 1, further comprising:
performing a target task using the updated first embedding model.

17. The method of claim 16, wherein the first embedding model is a model receiving a multi-modal sample comprising a pair of a sample of a first modal and a sample of a second modal and generating a multi-modal embedding, and
the performing of the target task comprises:
constructing an input sample using a non-dummy sample belonging to the first modal and a dummy sample belonging to the second modal;
obtaining a multi-modal embedding for the input sample by inputting the input sample to the first embedding model;
extracting an embedding corresponding to the dummy sample from the obtained multi-modal embedding; and
performing a multi-modal task based on the extracted embedding.

18. The method of claim 17, wherein the multi-modal task is a text-to-image retrieval task or an image-to-text retrieval task,
the non-dummy sample is a query sample belonging to the first modal, and
the performing of the multi-modal task comprises:
selecting a sample of which a similarity to the extracted embedding is greater than or equal to a reference value among samples belonging to the second modal; and
providing the selected sample as a retrieval result for the query sample.

19. A system for embedding data, comprising:
one or more processors; and
a memory storing one or more instructions,
wherein the one or more processors, by executing the stored one or more instructions, perform operations comprising:
generating a first view sample corresponding to a local view of a reference sample,
generating a second view sample corresponding to a view greater than the local view from the reference sample,
generating a first output value by inputting the first view sample to a first embedding model,
generating a second output value by inputting the second view sample to a second embedding model, and
updating parameters of the first embedding model based on a difference between the first output value and the second output value.

20. A computer program stored in a computer-readable recording medium coupled to a computing device to execute operations comprising:
generating a first view sample corresponding to a local view of a reference sample;
generating a second view sample corresponding to a view greater than the local view from the reference sample;
generating a first output value by inputting the first view sample to a first embedding model;
generating a second output value by inputting the second view sample to a second embedding model; and
updating parameters of the first embedding model based on a difference between the first output value and the second output value.
